(19) United States
(12) Patent Application Publication
(10) Pub. No.: US 2018/0205695 A1
(43) Pub. Date: Jul. 19, 2018

(54) MESSAGING APPLICATION SELECTION FOR OPTIMAL COMMUNICATIONS

(71) Applicant: International Business Machines Corporation, Armonk, NY (US)

(72) Inventor: Mariko Tagawa, Tokyo (JP)

(21) Appl. No.: 15/408,340

(22) Filed: Jan. 17, 2017

(51) Int. Cl. H04L 29/12; H04L 29/08; H04L 12/58

(52) U.S. Cl. CPC H04L 61/1594; H04L 67/306; H04L 51/32; H04L 67/22; H04L 51/04; H04L 51/043

(57) ABSTRACT

Embodiments of the invention provide a method, system and computer program product for communications modality selection. In one embodiment, a communications modality selection method includes first receiving from a contact, an address book that includes a listing of multiple different communications modalities of the contact and corresponding addresses at which the multiple different modalities may be accessed so as to communicate with the contact. The method also includes receiving thereafter a request from an end user to communicate with the contact. Finally, the method includes responding to the request by locating in the address book of the contact the listing of the multiple different communications modalities, selecting one of the modalities for use in communicating with the contact and initiating an attempt to establish communications between the end user and the contact by accessing the selected one of the communications modalities at a corresponding one of the addresses.

### BACKGROUND OF THE INVENTION

### Field of the Invention

The present invention relates to communications and more particularly to selecting an application for use in transmitting a message.

### Description of the Related Art

Messaging is the lifeblood of the Internet. The ability for different users geographically dispersed about the globe to exchange messages instantaneously and to universally read those messages irrespective of the type of computer involved has enabled the explosive growth of computing worldwide. Messaging generally includes not only traditional, asynchronous forms of communication including e-mail, voice mail, discussion forums, blogging, wikis, shared calendaring and tasking, but also synchronous forms of communication including voice conversations, instant messaging, group chats, and the like. Irrespective of the mode of messaging, however, that remote individuals can instantaneously communicate provides the pulse of modern computing.

The ease in which end users can compose and transmit messages to others in an instantaneous fashion is not without consequence, however. Whereas legacy forms of communication—namely the “land line” telephone, facsimile and postal service—required the presence of a communicant at a specific location and also some effort on the part of communicants in physically being present to engage in a conversation, composing and transmitting a message like an e-mail or instant message requires little effort and is not restricted to any particular location given the ubiquity of mobile data communications and mobile computing devices and smartphones. Accordingly, the volume of messages traversing the global Internet each minute far exceeds by orders of magnitude those messages transmitted using traditional methods. As a result, entirely new management tools are required to manage the sheer mass of messages end users receive and process each day.

To address the problem of message management for a large volume of messages, tools have been developed to prioritize messages either manually or automatically. Once messages have been prioritized, the messages can be sorted in a view to the messages so that the messages of highest priority can appear within eyeshot of an end user. Consequently, the end user can process those messages of greatest importance first, leaving those messages of lesser importance for later processing. Most tools permit the classification of messages by numerical priority, and advanced tools perform prioritization according to the identity of the sender of the message, the time of receipt of the message or keywords in the subject line of the message.

Recently, message management systems have combined different prioritization criteria for automatically sorting and/or filtering messages wherein each of the criteria can be manually weighted by the end user to express a preferred balancing of application of the criteria to inbound messages. Exemplary criteria include whether or not the sender is recognized as an entry in the address book of the recipient, the priority of the message as established by the sender, the extent of participation of the recipient in a thread associated with the message (known as thread participation), and whether the message recipient was designated as the direct recipient, or as the recipient of a carbon copy or blind carbon copy (known as message directness).

### BRIEF SUMMARY OF THE INVENTION

Embodiments of the present invention address deficiencies of the art in respect to messaging and provide a novel and non-obvious method, system and computer program product for communications modality selection. In an embodiment of the invention, a communications modality selection method includes first receiving from a contact, an address book that includes a listing of multiple different communications modalities of the contact and corresponding addresses at which the multiple different modalities may be accessed so as to communicate with the contact. The method also includes receiving thereafter a request from an end user to communicate with the contact. Finally, the method includes responding to the request by locating in the address book of the contact the listing of the multiple different communications modalities, selecting one of the modalities for use in communicating with the contact and initiating an attempt to establish communications between the end user and the contact by accessing the selected one of the communications modalities at a corresponding one of the addresses.

In one aspect of the embodiment, the selected one of the communications modalities is selected for use in communicating with the contact only if it is determined that the contact is online as indicated by presence awareness for the selected one of the communications modalities. In another aspect of the embodiment, the selected one of the communications modalities is selected for use in communicating with the contact only if it is determined that a mobile device associated with the selected one of the communications modalities is powered on. In yet another aspect of the embodiment, the method additionally includes locating in the address book, a usage frequency of the each of the communications modalities by the contact at different times of the day and selecting the one of the communications modalities for use in communicating with the contact based upon a highest usage frequency at a time of the day corresponding to a time of day of the received request.

In yet another aspect of the embodiment, a level of confidentiality of the communications to be established with the contact is determined based upon a keyword included in a message intended for delivery to the contact. Then, a rating of confidentiality of each of the communications modalities is located in the address book. Finally, the one of the communications modalities is selected for use in communicating with the contact based upon a rating of confidentiality corresponding to the determined level of confidentiality.

In yet another aspect of the embodiment, the selected one of the communications modalities for use in communicating with the contact is e-mail associated with a business e-mail address of the contact when a number of past e-mail messages exchanged between the end user and the contact is below a threshold value. But, the selected one of the communications modalities for use in communicating with the contact is e-mail associated with a personal e-mail address of the contact when a number of past e-mail messages exchanged between the end user and the contact is above a threshold value.

Finally, in even yet another aspect of the embodiment, subsequent to an attempt to establish communications with the contact by way of e-mail, in response to a determination that an e-mail message has been transmitted but remains unread by the contact after a threshold duration of time has past since the transmission of the e-mail message, a different one of the communications modalities at a different corresponding one of the addresses is selected and an attempt initiated to establish communications with the contact by accessing the selected different one of the communications modalities at the different corresponding one of the addresses.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for communications modality selection;

FIG. 2 is a schematic illustration of a data processing system configured for communications modality selection; and,

FIG. 3 is a flow chart illustrating a process for communications modality selection.

### DETAILED DESCRIPTION OF THE INVENTION

Embodiments of the invention provide for communications modality selection. In accordance with an embodiment of the invention, an address book for a contact is received by an end user. The address book includes a selection of different communications modalities such as telephone, e-mail, text messaging, social media messaging and the like. The address book also includes associated addresses at which communications with the contact at a corresponding one of the modalities may be established, along with additional information for each of the modalities such as a frequency of utilization of a particular one of the modalities during a particular time period or on a particular day. The content of the address book may be limited depending upon a past degree of interaction between the end user and the contact with a higher degree of interaction resulting in a greater and more personal selection of modalities. Thereafter, upon receiving a request by the end user to establish communications with the contact, the address book is consulted so as to match a context of the request such as a time of day or day of the week with a corresponding one of the modalities listed in the address book. Finally, the matched one of the modalities is used to attempt communications with the contact.

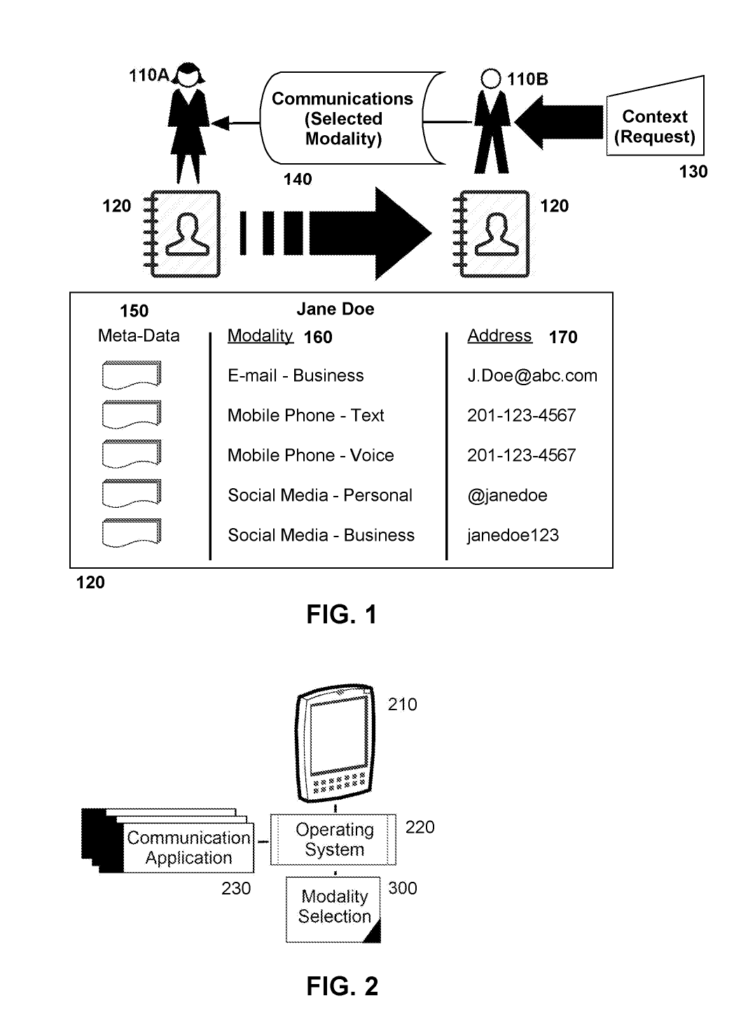

In further illustration, FIG. 1 is a pictorial illustration of a process for communications modality selection. As shown in FIG. 1, a contact 110A provides an address book 120 for the contact to end user 110B. The address book 120 includes for the contact 110 a selection of communications modalities 160 by which communications may be established with the contact 110. Those modalities 160 include, by way of example, e-mail, instant messaging, telephone, texting and social media messaging to name a few. As well, the address book 120 includes associated addressing information 170 for each corresponding one of the modalities such as an e-mail address, telephone number or social media handle or user identifier. Finally, the address book 120 includes modality meta-data 150. The modality meta-data 150 provides additional information for each of the modalities, such as a frequency of use by the contact 110A during a particular time period, or a level of confidentiality associated with a corresponding one of the modalities 160.

The extent of the selection of communications modalities 160 may be limited in the case of a below threshold number of interactions between the contact 110A and end user 110B, to only those of the modalities 160 that are business oriented such as business e-mail or business social media or a business telephone. But, to the extent that a threshold number of interactions has occurred between the contact 110A and end user 110B, additional ones of the modalities 160 may be included in the address book 120 such as personal e-mail and personal social media as well as a personal cellular telephone or home telephone.

Once the end user 110B has received the address book 120 from the contact 110A, a subsequent request by the end user 110B to establish communications with the contact 110A results in the consultation of the address book 120 to select from amongst the modalities 160, a particular one of the modalities 160 with which communications 140 is to be attempted with the contact 110A. In this regard, a context 130 of the request is determined such as a time of day, day of the week, or degree of confidentiality required for the communications 140. The context 130 is then compared to the modality meta-data 150 in order to select one of the modalities 160 and a corresponding one of the addresses 170. Finally, the communications 140 are attempted using the selected one of the modalities 160 at the corresponding one of the addresses 170.

The process described in connection with FIG. 1 may be implemented in a data processing system. In yet further illustration, FIG. 2 schematically shows a data processing system configured for communications modality selection. The system includes a client computing device 210, for instance a personal computer or mobile smart phone with memory and at least one processor. An operating system 220 executes in the memory of the client computing device 210 and supports the operation of different communications applications 230, such as a phone dialer, an e-mail client, a text messenger, an instant messenger and one or more social media applications whether Web based or stand-alone.

Of note, a modality selection module 300 also operates in the operating system 220, or in the alternative, in a computing system disposed remotely over a computer communications network. The modality selection module 300 includes program code that when executed, receives from different contacts from over a computer communications network, respectively different address books. Each address book of a contact includes a selection of communication modalities and meta-data therefore, in addition to a corresponding address at which communications may be established, such as a telephone number, e-mail address or social media handle. The program code of the modality selection module 300 as well is enabled upon execution to receive a request to establish communications with a particular contact. The program code of the modality selection module 300 even yet further is enabled to respond to the request by locating an address book for the particular contact and to select one of the modalities in the address book based upon a context of the request. Finally, the program code of the modality selection module 300 during execution is enabled in response to request to attempt to establish communications with the particular contact at an address for the selected one of the modalities.

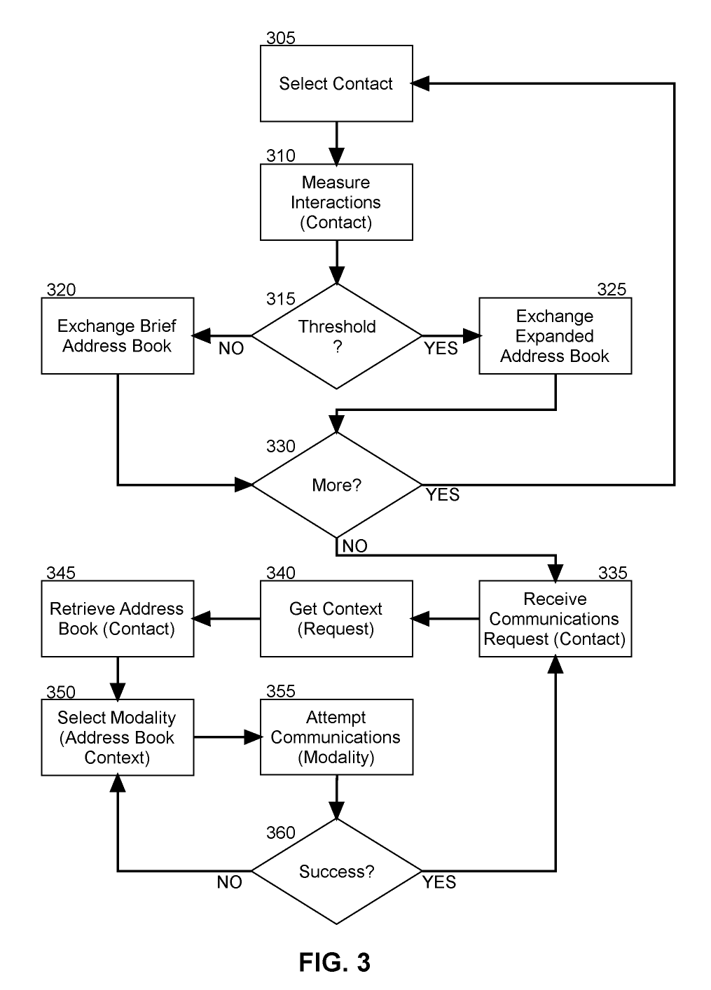

In even yet further illustration of the operation of the modality selection module 300, FIG. 3 is a flow chart illustrating a process for communications modality selection. Beginning in block 305, a contact is selected for an end user and in block 310, a number of interactions between the contact and end user are measured—namely a number of times the contact has communicated with the end user. In decision block 315, if the number of interactions fails to exceed a threshold value, in block 320 only a brief form of an address book for the selected contact is provided to the end user (and the end user provides to the selected contact an abbreviated form of an address book for the end user). However, in decision block 315, if the number of interactions exceeds the threshold value, then in block 325 an expanded form of the address book for the selected contact is provided to the end user and the end user provides an expanded form of the of the address book for the end user. In decision block 330, if more contacts of the end user remain to be processed, the process returns to block 305.

In block 335, a communications request to communicate with a contact is received in block 335 and in block 340, a context of the request is retrieved—for example a time of day of the request or a level of confidentiality required for the requested communications, whether through presence awareness the contact is actively interacting with a computing device, or whether or not a mobile computing device of the contact has been powered on. In block 345, an address book for the contact is retrieved and in block 350, a modality in the address book is selected based upon the context. In block 355 an attempt to establish communications with the contact using the selected modality begins. In decision block 360, if the attempt is not successful, the process returns to block 350 with the selection of a different modality in the address book. However, in decision block 360, if the attempt is successful, the process returns to block 335 in which a new request to communicate with a different contact is received.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

I claim:

1. A communications modality selection method comprising:
receiving from a contact, an address book comprising a listing of multiple different communications modalities of the contact and corresponding addresses at which the multiple different modalities may be accessed so as to communicate with the contact;
receiving thereafter a request from an end user to communicate with the contact; and,
in response to the request, locating in the address book of the contact the listing of the multiple different communications modalities, selecting one of the modalities for use in communicating with the contact and initiating an attempt to establish communications between the end user and the contact by accessing the selected one of the communications modalities at a corresponding one of the addresses.

2. The method according to claim 1, wherein the selected one of the communications modalities is selected for use in communicating with the contact only if it is determined that the contact is online as indicated by presence awareness for the selected one of the communications modalities.

3. The method according to claim 1, wherein the selected one of the communications modalities is selected for use in communicating with the contact only if it is determined that a mobile device associated with the selected one of the communications modalities is powered on.

4. The method of claim 1, further comprising:
locating in the address book, a usage frequency of the each of the communications modalities by the contact at different times of the day; and,
selecting the one of the communications modalities for use in communicating with the contact based upon a highest usage frequency at a time of the day corresponding to a time of day of the received request.

5. The method according to claim 1, further comprising:
determining a level of confidentiality of the communications to be established with the contact based upon a keyword included in a message intended for delivery to the contact;
locating in the address book, a rating of confidentiality of the each of the communications modalities; and,
selecting the one of the communications modalities for use in communicating with the contact based upon a rating of confidentiality corresponding to the determined level of confidentiality.

6. The method according to claim 1, wherein the selected one of the communications modalities for use in communicating with the contact is either e-mail associated either with a business e-mail address of the contact when a number of past e-mail messages exchanged between the end user and the contact is below a threshold value, or is e-mail associated with a personal e-mail address of the contact when a number of past e-mail messages exchanged between the end user and the contact is above a threshold value.

7. The method according to claim 1, wherein subsequent to an attempt to establish communications with the contact by way of e-mail, in response to a determination that an e-mail message has been transmitted but remains unread by the contact after a threshold duration of time has past since the transmission of the e-mail message, a different one of the communications modalities at a different corresponding one of the addresses is selected and an attempt initiated to establish communications with the contact by accessing the selected different one of the communications modalities at the different corresponding one of the addresses.

8. A data processing system configured communications modality selection comprising:
a host computing platform comprising at least one computer with memory and at least one processor; and,
a communications module executing in the memory of the host computing platform, the module comprising program code enabled upon execution in the memory of the host computing platform to perform the steps of:
receiving from a contact, an address book comprising a listing of multiple different communications modalities of the contact and corresponding addresses at which the multiple different modalities may be accessed so as to communicate with the contact;
receiving thereafter a request from an end user to communicate with the contact; and,
in response to the request, locating in the address book of the contact the listing of the multiple different communications modalities, selecting one of the modalities for use in communicating with the contact and initiating an attempt to establish communications between the end user and the contact by accessing the selected one of the communications modalities at a corresponding one of the addresses.

9. The system according to claim 8, wherein the program code of the module is further enabled to perform the steps of:
locating in the address book, a usage frequency of the each of the communications modalities by the contact at different times of the day; and,
selecting the one of the communications modalities for use in communicating with the contact based upon a highest usage frequency at a time of the day corresponding to a time of day of the received request.

10. The system according to claim 8, wherein the program code of the module is further enabled to perform the steps of:
determining a level of confidentiality of the communications to be established with the contact based upon a keyword included in a message intended for delivery to the contact;
locating in the address book, a rating of confidentiality of the each of the communications modalities; and,
selecting the one of the communications modalities for use in communicating with the contact based upon a rating of confidentiality corresponding to the determined level of confidentiality.

11. The system according to claim 8, wherein the selected one of the communications modalities for use in communicating with the contact is either e-mail associated either with a business e-mail address of the contact when a number of past e-mail messages exchanged between the end user and the contact is below a threshold value, or is e-mail associated with a personal e-mail address of the contact when a number of past e-mail messages exchanged between the end user and the contact is above a threshold value.

12. A computer program product for communications modality selection, the computer program product comprising a computer readable storage medium having program instructions embodied therewith, the program instructions executable by a device to cause the device to perform a method comprising:
receiving from a contact, an address book comprising a listing of multiple different communications modalities of the contact and corresponding addresses at which the multiple different modalities may be accessed so as to communicate with the contact;
receiving thereafter a request from an end user to communicate with the contact; and,
in response to the request, locating in the address book of the contact the listing of the multiple different communications modalities, selecting one of the modalities for use in communicating with the contact and initiating an attempt to establish communications between the end user and the contact by accessing the selected one of the communications modalities at a corresponding one of the addresses.

13. The computer program product according to claim 12, wherein the selected one of the communications modalities is selected for use in communicating with the contact only if it is determined that the contact is online as indicated by presence awareness for the selected one of the communications modalities.

14. The computer program product according to claim 12, wherein the selected one of the communications modalities is selected for use in communicating with the contact only if it is determined that a mobile device associated with the selected one of the communications modalities is powered on.

15. The computer program product of claim 12, wherein the method further comprises:
locating in the address book, a usage frequency of the each of the communications modalities by the contact at different times of the day; and,
selecting the one of the communications modalities for use in communicating with the contact based upon a highest usage frequency at a time of the day corresponding to a time of day of the received request.

16. The computer program product of claim 12, wherein the method further comprises:
determining a level of confidentiality of the communications to be established with the contact based upon a keyword included in a message intended for delivery to the contact;
locating in the address book, a rating of confidentiality of the each of the communications modalities; and,
selecting the one of the communications modalities for use in communicating with the contact based upon a rating of confidentiality corresponding to the determined level of confidentiality.

17. The computer program product according to claim 12, wherein the selected one of the communications modalities for use in communicating with the contact is either e-mail associated either with a business e-mail address of the contact when a number of past e-mail messages exchanged between the end user and the contact is below a threshold value, or is e-mail associated with a personal e-mail address of the contact when a number of past e-mail messages exchanged between the end user and the contact is above a threshold value.

18. The computer program product according to claim 12, wherein subsequent to an attempt to establish communications with the contact by way of e-mail, in response to a determination that an e-mail message has been transmitted but remains unread by the contact after a threshold duration of time has past since the transmission of the e-mail message, a different one of the communications modalities at a different corresponding one of the addresses is selected and an attempt initiated to establish communications with the contact by accessing the selected different one of the communications modalities at the different corresponding one of the addresses.
